(19) United States
(12) Patent Application Publication
(10) Pub. No.: US 2019/0092255 A1
(43) Pub. Date: Mar. 28, 2019

(54) WIRE HARNESS

(71) Applicant: SUMITOMO WIRING SYSTEMS, LTD., Yokkaichi-shi, Mie (JP)

(72) Inventor: Hirokazu NAKAI, Yokkaichi (JP)

(73) Assignee: SUMITOMO WIRING SYSTEMS, LTD., Yokkaichi-shi, Mie (JP)

(21) Appl. No.: 16/086,857

(22) PCT Filed: Apr. 3, 2017
(86) PCT No.: PCT/JP2017/013906

§ 371 Date: Sep. 20, 2018

(30) Foreign Application Priority Data
Apr. 7, 2016 (JP) 2016-077092

(51) Int. Cl. B60R 16/02; H01B 7/00; H02G 3/04

(52) U.S. Cl. CPC B60R 16/0215; H02G 3/0481; H01B 7/0045

(57) ABSTRACT

A wire harness where the hard conductor portion is arranged inside of the hard outer covering portion and the hard outer covering portion and the hard conductor portion are bent together to form a bent portion, the conductor is formed by twisting together a plurality of strands, and includes a single core that is formed by the strands coming into close contact with each other and being integrated due to pressure being applied to a predetermined part of the conductor, and a twisted wire that is not pressed and is left in a state in which the plurality of strands are twisted together, the single core forms the hard conductor portion, a level difference is formed on a boundary between the single core and the twisted wire, and a positioner for positioning the level difference is provided on an inner circumferential surface of the outer covering.

This application is the U.S. National Phase of PCT/JP2017/013906 filed Apr. 3, 2017, which claims priority to JP 2016-077092 filed Apr. 7, 2016, the entire disclose is incorporated herein by reference.

### BACKGROUND

The present disclosure relates to a wire harness.

A wire harness including one or multiple wires has conventionally been known. The wires are protected by being inserted through an outer covering member such as a corrugated tube, and are fixed to a vehicle body or the like with fixing clamps or the like. Since the corrugated tube is flexible, there is concern that the wire harness will sag between the fixing clamps due to the weight of the wires. In view of this, as described in JP 2013-243900A below for example, it is known that an outer covering material having a straight pipe portion and an accordion portion is used. The straight pipe portion maintains a linear shape, and therefore can prevent sagging, and the wire harness can be formed on a predetermined routing path by bending the accordion portion to a predetermined angle.

### SUMMARY

However, in the above-described configuration, the accordion portion of the outer covering material bends flexibly, and therefore the bent shape of the wire harness cannot be maintained. For this reason, for example, when attaching the wire harness, the task needs to be performed while bending the accordion portion to a predetermined bent shape and holding the shape, and thus there is a problem in that the task requires labor.

An exemplary aspect of the disclosure provides a wire harness that can maintain a predetermined bent shape.

The wire harness of the present disclosure includes: a conductor that includes a hard conductor portion that can hold a bent shape; and an outer covering that surrounds the conductor and that includes a hard outer covering portion that can hold a bent shape, wherein: the hard conductor portion is arranged inside of the hard outer covering portion and the hard outer covering portion and the hard conductor portion are bent together to form a bent portion, the conductor is formed by twisting together a plurality of strands, and includes a single core that is formed by the strands coming into close contact with each other and being integrated due to pressure being applied to a predetermined part of the conductor, and a twisted wire that is not pressed and is left in a state in which the plurality of strands are twisted together, the single core forms the hard conductor portion, a level difference is formed on a boundary between the single core and the twisted wire, and a positioner for positioning the level difference is provided on an inner circumferential surface of the outer covering.

According to the present disclosure, a hard outer covering portion that is bent tries to return somewhat to its original shape due to springback, but the shape is held by a hard conductor portion made of a conductor that is also bent, and therefore the wire harness can maintain a predetermined bent shape.

### BRIEF DESCRIPTION OF THE DRAWINGS

FIG. 1 is a schematic diagram showing a wire harness of the present embodiment in a state of being attached to a vehicle body.

FIG. 2 is a side view showing an outer cover member and a conductor.

FIG. 3A is an enlarged view showing a state in which a conductor is inserted through the outer covering member, and FIG. 3B is an enlarged view showing a state in which the conductor is positioned on the outer covering member.

### DETAILED DESCRIPTION OF EMBODIMENTS

Preferred embodiments of the present disclosure will be described below.

In the wire harness of the present disclosure, the conductor may be formed by twisting together multiple strands, the wire harness may include a single core portion formed by the strands coming into close contact and integrating with each other due to a force being applied to a predetermined part of the conductor, and a twisted wire portion that is not pressed and is left in a state in which the multiple strands are twisted together, the single core portion constituting the hard conductor portion. With this kind of configuration, the hard conductor portion can be formed integrally with the conductor.

Also, in the wire harness of the present disclosure, a level difference portion may be formed on the boundary portion between the single core portion and the twisted wire portion, and a positioning portion for positioning the level difference portion may be provided on the inner circumferential surface of the outer covering member. With this kind of configuration, the outer covering portion and the conductor can be positioned in the axial direction, and therefore the hard outer covering portion and the hard conductor portion can be reliably arranged at the part to be bent.

### Embodiment

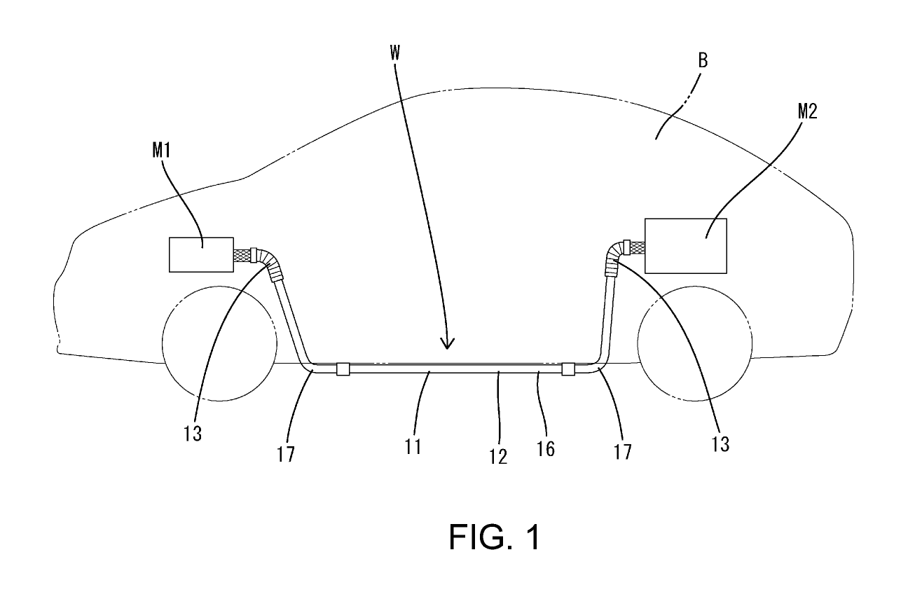

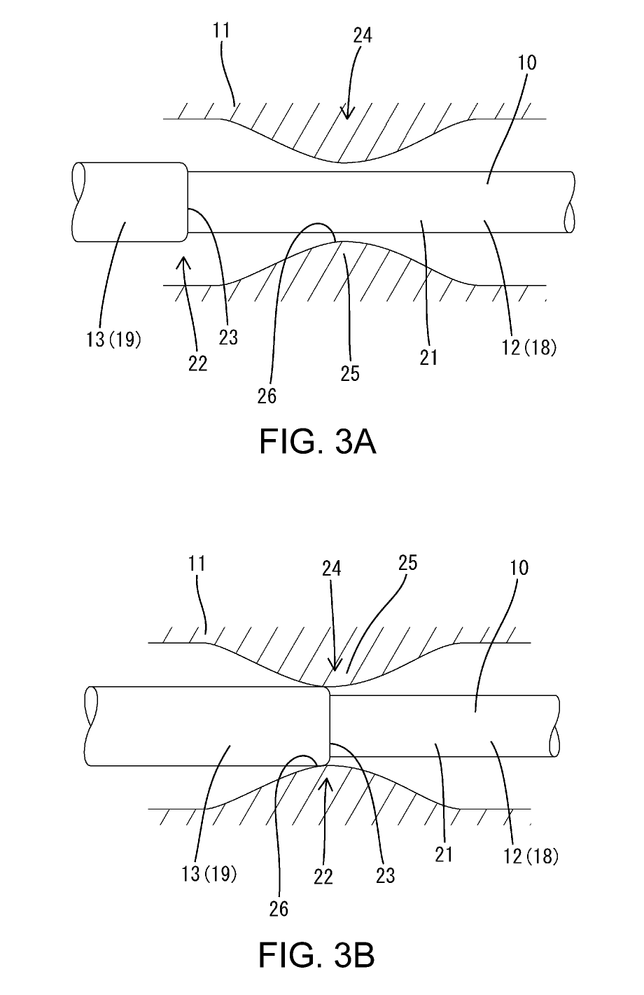

Hereinafter, an embodiment specifically describing the present disclosure will be described in detail with reference to FIGS. 1 to 3.

A wire harness W of the present embodiment is a low-voltage harness to be mounted in a vehicle or the like, and connects a device M1 such as an auxiliary battery (12-V battery) arranged in the front portion of a vehicle body B, for example, and a device M2 such as a PDU (Power Drive Unit) arranged in the rear portion of the vehicle body B. The wire harness W is routed extending in the front-rear direction along the underfloor of the vehicle body B, and both the front and rear end portions thereof are bent upward toward the vehicle interior.

The wire harness W includes multiple (in the present embodiment, two) conductors 10, and an outer covering member 11 (i.e., outer covering) that collectively surrounds the multiple conductors 10. The conductors 10 are insulated and protected by the outer covering member 11.

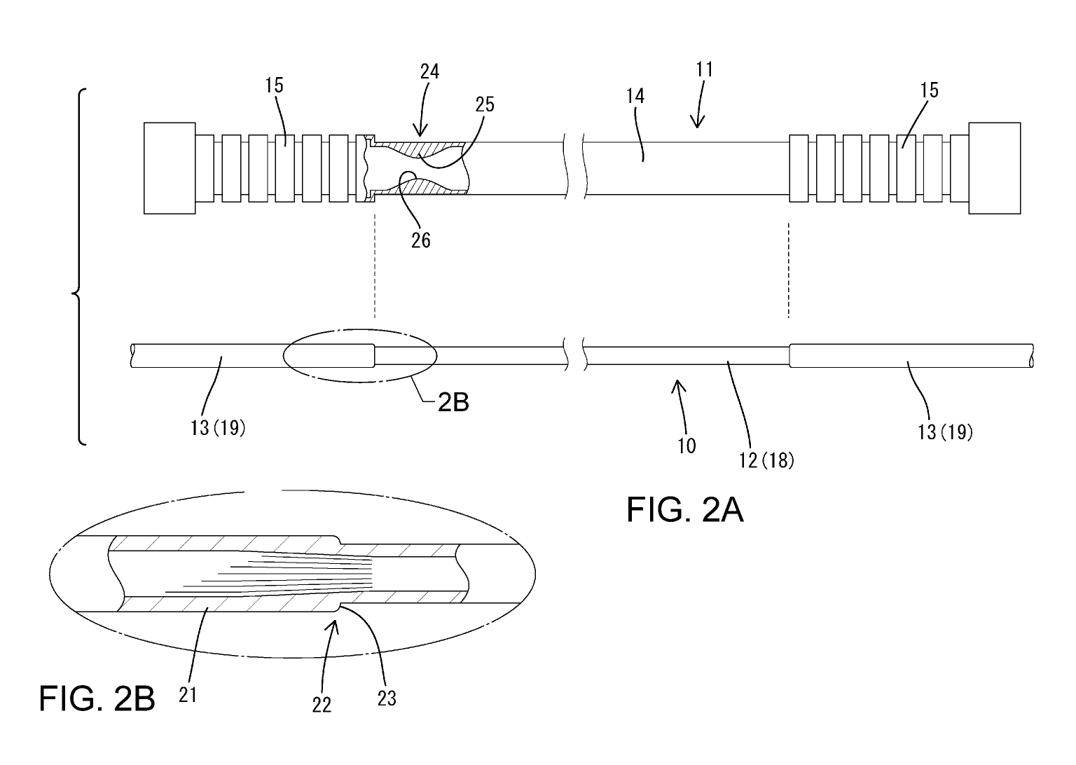

Each conductor 10 includes: a hard conductor portion 12 that has rigidity and can hold a bent shape; and soft conductor portions 13 that have flexibility (bendability) and can be bent to any shape. As shown in FIG. 2, the hard conductor portion 12 is provided in the intermediate portion in the lengthwise direction of the conductors 10 and is routed mainly on the underfloor of the vehicle body B. The soft conductor portions 13 are provided on both end portions in the lengthwise direction of the conductors 10, and connectors (not shown) that are connected to the devices M1 and M2 are provided on the end portions.

The conductor 10 is formed by twisting multiple strands together into a spiral shape and is composed of any metal material with excellent conductivity, such as aluminum, an aluminum alloy, copper, or a copper alloy. The conductor 10 includes: a single core portion 18 (i.e., single core) that is formed by applying pressure to a predetermined part of the twisted-together strands so that the strands strongly come into close contact with each other and are integrated; and a twisted wire portion 19 (i.e., twisted wire) that is not pressed and is left in a state in which the multiple strands are twisted together. The single core portion 18 has a relatively high rigidity, does not bend easily, and has an excellent shape maintaining ability. The twisted wire portion 19 has low rigidity, bends easily, and has high flexibility.

The single core portion 18 is formed by applying pressure through pressing or the like to a predetermined part (part in which the single core portion 18 is to be formed) of the unpressed conductors. The unpressed conductors are bare wires that have not been surrounded by an insulating coating 21. Note that ultrasonic welding, resistance welding, or the like may be used during pressing.

When approximately equal pressure is applied to the entire circumference of the conductor, the gaps between the conductors (gaps between the strands) are gradually eliminated, the strands strongly come into close contact with each other and are integrated until the interfaces between the strands are eliminated, and thus the single core portion 18 having a circular cross section is formed. The single core portion 18 and the twisted wire portions 19 are formed continuously in the axial direction of the conductor 10. The outer circumferential dimension of the single core portion 18 is smaller than the outer circumferential dimension of the twisted wire portion 19.

The insulating coating 21 is attached to the conductor 10 on which the single core portion 18 and the twisted wire portions 19 are formed. The insulating coating 21 surrounds almost the entire length of the conductor 10. In the outer circumferential portion of the insulating coating 21, level difference portions 22 (i.e., level differences) are formed on the boundary portions (i.e., boundaries) between the single core portion 18 and the twisted wire portions 19. The level difference portions 22 are located on both ends in the axial direction of the single core portion 18 of the conductor 10. The level difference portions 22 are formed with the twisted wire portion 19 sides protruding outward with respect to the single core portion 18 sides over the entire circumference of the conductor 10. The level difference portions 22 include level difference surfaces 23 that are approximately orthogonal to the axis line of the conductor 10.

The hard conductor portion 12 is constituted by the single core portion 18 of the conductor 10, and the soft conductor portions 13 are constituted by the twisted wire portions 19 of the conductor 10.

The outer covering member 11 is made of synthetic resin and includes a hard outer covering portion 14 that has rigidity and can hold a bent shape, and soft outer covering portions 15 that have flexibility (bendability) and can be bent into any shape. The hard outer covering portion 14 and the soft outer covering portions 15 are formed integrally. The hard outer covering portion 14 has a circular tube shape with no unevenness and an approximately constant cross-sectional shape, and is not flexible like the soft outer covering portions 15. The soft outer covering portions 15 have an accordion shape in which peak portions and valley portions are continuously arranged alternatingly in the axial direction.

As shown in FIG. 2, the hard conductor portion 14 is provided in the intermediate portion in the lengthwise direction of the outer covering member 11 and is routed mainly on the underfloor of the vehicle B. The outer circumferential dimension of the hard outer covering portion 14 is smaller than the outer circumferential dimension of the soft outer covering portions 15, and thus is suitable for routing on the underfloor. The soft outer covering portions 15 are provided on both end portions in the lengthwise direction of the outer covering material 11. The soft outer covering portions 15 can easily be bent, and therefore are suitable for performing a task of connecting the devices M1 and M2.

In the wire harness W, the hard conductor portion 12 is arranged inside of the hard outer covering portion 14, and the soft conductor portions 13 are arranged inside of the soft outer covering portions 15. The length dimensions of the hard outer covering portion 14 and the hard conductor portion 12 are equal, and the length dimensions of the soft outer covering portions 15 and the soft conductor portions 13 are equal. That is, the entire length of the hard conductor portion 12 is surrounded by the hard outer covering portion 14, and the entire length of each soft conductor portion 13 is surrounded by a soft outer covering portion 15. Also, the boundary portions (level difference portions 22) between the hard conductor portion 12 and the soft conductor portions 13 are arranged near the boundaries between the hard outer covering portion 14 and the soft outer covering portions 15.

The wire harness W is formed into a shape that conforms to a predetermined routing path by bending the portion (hereinafter referred to as “hard body portion 16”) formed by the hard conductor portion 12 being arranged inside of the hard outer covering portion 14. At bent portions 17 of the hard body portion 16, the hard outer covering portion 14 and the hard conductor portion 12 are both bent.

As shown in FIG. 2, a positioning portion 24 (i.e., positioner) that positions the conductors 10 is provided on the inner circumferential surface of the outer covering member 11. The positioning portion 24 is provided on one end portion (the end portion on the rear side in the insertion direction of the conductor 10) of the hard outer covering portion 14 of the outer covering material 11.

The positioning portion 24 includes a bulging portion 25 that is formed so as to tighten the path of the conductor 10. The bulging portion 25 is provided on the inner circumferential surface of the outer covering member 11 and bulges inward over the entire circumference of the outer covering member 11. The bulging portion 25 has a gently-sloping peak shape, the two sides in the axial direction are inclined surfaces, and the intermediate portion in the axial direction is a peak portion 26 that protrudes the furthest inward. The level difference portion 22 of the conductor 10 hooks onto the positioning portion 24.

Next, an example of a method for manufacturing the wire harness W will be described.

First, the conductor 10 is inserted through the outer covering member 11. When one end side of the conductor 10 is inserted into one end side (the side near the positioning portion 24) of the outer covering member 11, the soft conductor portion 13 on the front side in the insertion direction enters the outer covering member 11 and hooks onto the positioning portion 24 of the outer covering member 11. However, by continuing the pressing task, the soft conductor portion 13 passes through the positioning portion 24 and advances to the other end side of the outer covering member 11.

When the soft conductor portion 13 goes past the positioning portion 24, the hard conductor portion 12 reaches the positioning portion 24, and the hard conductor portion 12, which has a small circumferential dimension, smoothly passes through the positioning portion 24.

When the hard conductor portion 12 finishes passing through the positioning portion 24, the soft conductor portion 13 on the rear side in the insertion direction reaches the positioning portion 24 and the level difference portion 22 hooks onto the peak portion 26 of the positioning portion 24. Due to this response, it is possible to check that the conductor 10 is arranged at a predetermined position of the outer covering member 11. In this manner, the conductor 10 is positioned in a state in which the hard conductor portion 12 is arranged inside of the hard outer covering portion 14 and the soft conductor portions 13 are arranged inside of the soft outer covering portions 15.

Next, the bent portions 17 are formed. Predetermined locations of the hard outer covering portion 14 are bent along with the conductor 10. Due to the bending, the hard outer covering portion 14 and the hard conductor portion 12 bend into the same shape, and the bent portions 17 of the wire harness W are formed.

Due to this, the manufacture of the wire harness W is complete.

Next, actions and effects of the thus-configured embodiment will be described.

The wire harness W of the present embodiment includes conductors 10 and an outer covering member 11 that surrounds the conductors 10, a hard conductor portion 12 that has rigidity and can hold a bent shape is provided on the conductors 10, a hard outer covering portion 14 that has rigidity and can hold a bent shape is provided on the outer covering portion 11, the hard conductor portion 12 is arranged inside of the hard outer covering portion 14, and the hard outer covering portion 14 and the hard conductor portion 12 are both bent to form the bent portions 17.

According to this configuration, the bent hard outer covering portion 14 tries to return somewhat to its original shape due to springback, but the shape is held by the hard conductor portion 12 of the conductor 10 that was also bent. Accordingly, the wire harness W can maintain the predetermined bent shape.

Also, the level difference portions 22 are formed on the boundary portions between the single core portion 18 and the twisted wire portions 19, and the positioning portion 24 that positions the level difference portion 22 is provided on the inner circumferential surface of the outer covering member 11. According to this configuration, the outer covering member 11 and the conductor 10 can be positioned in the axial direction, and therefore the hard outer covering portion 14 and the hard conductor portion 12 are reliably arranged at the part to be bent.

### Other Embodiments

The present disclosure is not limited to the embodiment described with reference to the above description and drawings, and for example, the following embodiments are also encompassed in the technical scope of the present disclosure.

(1) In the above-described embodiment, a case was described in which the wire harness W is a low-voltage harness, but there is no limitation to this, and the present disclosure can be applied also to a high-voltage harness.

(2) In the above-described embodiment, the wire harness W has two conductors 10, but there is no limitation to this, and there may be one or three or more conductors.

(3) In the above-described embodiment, the hard conductor portion 12 and the soft conductor portions 13 are constituted by the single core portion 18 and the twisted wire portions 19 of the conductor 10, but there is no limitation to this, and the hard conductor portion and soft conductor portions may be constituted by other conductors with different properties, the hard conductor portion may be a single core wire or a pipe member formed by surrounding a metal rod-shaped core wire in an insulating coating, for example, and the soft conductor portions may be twisted wires that are formed by surrounding a braided wire or a core wire in an insulating coating, the braided wire being formed by braiding metal strands with excellent conductivity, and the core wire being formed by twisting together multiple metal strands, for example.

(4) In the above-described embodiment, the soft outer covering portions 15 have an accordion shape, but there is no limitation to this, and the soft outer covering portions may be any shape as long as they are flexible.

(5) In the above-described embodiment, the hard outer covering portion 14 has a circular tube shape with no unevenness and an approximately constant cross-sectional shape, but there is no limitation to this, and the hard outer covering portion need only have a predetermined hardness, and for example, may be provided with ribs or the like that protrude.

(6) In the above-described embodiment, the hard outer covering portion 14 and the soft outer covering portions 15 are integrally formed, but there is no limitation to this, and the hard outer covering portion and the soft outer covering portions may be separate objects that are divided.

(7) In the above-described embodiment, the hard conductor portion 12 is arranged over the entire length of the hard outer circumferential portion 14, but there is no limitation to this, and the hard conductor portion need only be arranged on at least the bent portions of the hard outer covering portion, and for example, a soft conductor portion may be arranged at the linear portion of the hard outer covering portion that is not bent.

(8) In the above-described embodiment, the conductors 10 are surrounded by the insulating coating 21, but there is no limitation to this, and the conductors may be bare wires or the level difference portions may be formed on the conductors.

(9) In the above-described embodiment, the level difference portions 22 have the level difference surfaces 23, but there is no limitation to this, and for example, the level difference portions may have a protruding shape that gently inclines with respect to the axial direction.

(10) In the above-described embodiment, the single core portion 18 has a circular cross-section, but there is no limitation this, and the cross-section may be non-circular.

1. A wire harness comprising:
a conductor that includes a hard conductor portion that can hold a bent shape; and
an outer covering that surrounds the conductor and that includes a hard outer covering portion that can hold a bent shape, wherein:
the hard conductor portion is arranged inside of the hard outer covering portion and the hard outer covering portion and the hard conductor portion are bent together to form a bent portion,
the conductor is formed by twisting together a plurality of strands, and includes a single core that is formed by the strands coming into close contact with each other and being integrated due to pressure being applied to a predetermined part of the conductor, and a twisted wire that is not pressed and is left in a state in which the plurality of strands are twisted together,
the single core forms the hard conductor portion,
a level difference is formed on a boundary between the single core and the twisted wire, and
a positioner for positioning the level difference is provided on an inner circumferential surface of the outer covering.

2-3. (canceled)
